(19) United States
(12) Patent Application Publication
(10) Pub. No.: US 2025/0008434 A1
(43) Pub. Date: Jan. 2, 2025

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Xiaohong ZHANG, Beijing (CN)

(73) Assignee: NEC CORPORATION, Tokyo (JP)

(21) Appl. No.: 18/709,982

(22) PCT Filed: Nov. 17, 2021
(86) PCT No.: PCT/CN2021/131307

§ 371 Date: May 14, 2024

(51) Int. Cl. H04W 52/02; H04W 76/28

(52) U.S. Cl. CPC H04W 52/0229; H04W 76/28

(57) ABSTRACT

Embodiments of the present disclosure relate to methods, devices and computer readable media for communication. A terminal device determines a time window for monitoring a WUS from a network device. In response to receiving the WUS from the network device in the time window, the terminal device starts an on-duration operation of DRX based on a first time offset from an end of the reception of the WUS. In this way, a starting time of a DRX cycle may be dynamically determined, and a good tradeoff between latency and power consumption may be achieved. Accordingly, latency may be reduced and power consumption may also be reduced.

### TECHNICAL FIELD

Embodiments of the present disclosure generally relate to the field of telecommunication, and in particular, to methods, devices and computer storage media of communication for discontinuous reception (DRX).

### BACKGROUND

Power saving is an important topic for services with periodic packets, especially for an extended reality (XR) service such as virtual reality (VR), augmented reality (AR), cloud gaming, etc., A wake-up signal (WUS) is introduced to further enhance the power saving. A WUS window for WUS detection is configured before an on-duration of a DRX cycle and one or more monitoring occasions in the WUS window is configured. If a WUS indicating to start the on-duration is detected, an on-duration timer will be started at the beginning of the DRX cycle.

Typically, packets for services such as the XR service will arrive at radio access network (RAN) every 1/frames per second (FPS). The arriving tends to occur in a range of jitter due to various factors. An effect of jitter is identified as an important aspect for such services. However, the beginning of the DRX cycle is semi-statically configured without considering the jitter issue. This may cause a longer waiting time between arrival time of packets and a starting time of the on-duration or a longer and useless physical downlink control channel (PDCCH) monitoring.

### SUMMARY

In general, embodiments of the present disclosure provide methods, devices and computer storage media of communication for DRX.

In a first aspect, there is provided a method of communication. The method comprises: determining, at a terminal device, a time window for monitoring a wake-up signal from a network device; and in response to receiving the wake-up signal from the network device in the time window, starting an on-duration operation of discontinuous reception based on a first time offset from an end of the reception of the wake-up signal.

In a second aspect, there is provided a method of communication. The method comprises: determining, at a terminal device, a target search space set group from a configured set of search space set groups, the configured set of search space set groups comprising a search space set for monitoring a trigger signal used to activate a search space set group or trigger a search space set group switching; and starting an on-duration operation of discontinuous reception based on the target search space set group.

In a third aspect, there is provided a method of communication. The method comprises: in accordance with a determination that a search space set group switching from a first search space set group to a second search space set group is performed in a first short cycle of discontinuous reception, determining, at a terminal device, a search space set group from multiple search space set groups based on a timer associated with discontinuous reception; and starting an on-duration operation of discontinuous reception based on the determined search space set group in a second short cycle of discontinuous reception, the second short cycle being later than the first short cycle.

In a fourth aspect, there is provided a method of communication. The method comprises: determining, at a network device, a time window for transmitting a wake-up signal to a terminal device; and in response to transmitting the wake-up signal to the terminal device in the time window; starting an on-duration operation of discontinuous reception based on a first time offset from an end of the transmission of the wake-up signal.

In a fifth aspect, there is provided a method of communication. The method comprises: determining, at a network device, a target search space set group from a configured set of search space set groups, the configured set of search space set groups comprising a search space set for monitoring a trigger signal used to activate a search space set group or trigger a search space set group switching; and starting an on-duration operation of discontinuous reception based on the target search space set group.

In a sixth aspect, there is provided a method of communication. The method comprises: in accordance with a determination that a search space set group switching from a first search space set group to a second search space set group is performed in a first short cycle of discontinuous reception, determining, at a network device, a search space set group from multiple search space set groups based on a timer associated with discontinuous reception; and starting an on-duration operation of discontinuous reception based on the determined search space set group in a second short cycle of discontinuous reception, the second short cycle being later than the first short cycle.

In a seventh aspect, there is provided a device of communication. The device comprises a processor configured to perform the method according to any of the first to third aspect of the present disclosure.

In an eighth aspect, there is provided a device of communication. The device comprises a processor configured to perform the method according to any of the fourth to sixth aspect of the present disclosure.

In a ninth aspect, there is provided a computer readable medium having instructions stored thereon. The instructions, when executed on at least one processor, cause the at least one processor to perform the method according to any of the first to third aspect of the present disclosure.

In a tenth aspect, there is provided a computer readable medium having instructions stored thereon. The instructions, when executed on at least one processor, cause the at least one processor to perform the method according to any of the fourth to sixth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating an example operation in a DRX cycle;

FIG. 1C illustrates a schematic diagram illustrating an example operation of on-duration in a DRX cycle with WUS detection;

FIG. 2A illustrates a schematic diagram illustrating an example scenario of DRX with jitter of packets;

FIG. 2B illustrates a schematic diagram illustrating another example scenario of DRX with jitter of packets;

FIG. 3A illustrates a schematic diagram illustrating an example in which a WUS window before on-duration is configured;

FIG. 3B illustrates a schematic diagram illustrating an example in which a WUS is not configured;

FIG. 4A illustrates a schematic diagram illustrating a process for communication according to embodiments of the present disclosure;

FIG. 4B illustrates a schematic diagram illustrating an example on-duration operation in the process of FIG. 4A according to embodiments of the present disclosure;

FIG. 4C illustrates a schematic diagram illustrating another example on-duration operation in the process of FIG. 4A according to embodiments of the present disclosure;

FIG. 4D illustrates a schematic diagram illustrating still another example on-duration operation in the process of FIG. 4A according to embodiments of the present disclosure;

FIG. 4E illustrates a schematic diagram illustrating yet another example on-duration operation in the process of FIG. 4A according to embodiments of the present disclosure;

FIG. 4F illustrates a schematic diagram illustrating an example of multiple time windows associated with a single on-duration timer according to embodiments of the present disclosure;

FIG. 4G illustrates a schematic diagram illustrating an example of multiple time windows associated with multiple on-duration timers according to embodiments of the present disclosure;

FIG. 5A illustrates a schematic diagram illustrating another process for communication according to embodiments of the present disclosure;

FIG. 5B illustrates a schematic diagram illustrating an example on-duration operation in the process of FIG. 5A according to embodiments of the present disclosure;

FIG. 5C illustrates a schematic diagram illustrating another example on-duration operation in the process of FIG. 5A according to embodiments of the present disclosure;

FIG. 5D illustrates a schematic diagram illustrating still another example on-duration operation in the process of FIG. 5A according to embodiments of the present disclosure;

FIG. 5E illustrates a schematic diagram illustrating yet another example on-duration operation in the process of FIG. 5A according to embodiments of the present disclosure;

FIG. 6A illustrates a schematic diagram illustrating still another process for communication according to embodiments of the present disclosure;

FIG. 6B illustrates a schematic diagram illustrating an example DRX operation in the process of FIG. 6A according to embodiments of the present disclosure;

FIG. 7 illustrates an example method of communication implemented at a terminal device in accordance with some embodiments of the present disclosure;

FIG. 8A illustrates another example method of communication implemented at a terminal device in accordance with some embodiments of the present disclosure;

FIG. 8B illustrates an example method of starting an on-duration operation of DRX implemented at a terminal device in accordance with some embodiments of the present disclosure;

FIG. 9 illustrates still another example method of communication implemented at a terminal device in accordance with some embodiments of the present disclosure;

FIG. 10 illustrates an example method of communication implemented at a network device in accordance with some embodiments of the present disclosure;

FIG. 11 illustrates another example method of communication implemented at a network device in accordance with some embodiments of the present disclosure;

FIG. 12 illustrates still another example method of communication implemented at a network device in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “symbol” refers to an orthogonal frequency division multiplexing (OFDM) symbol or a discrete Fourier transform spread OFDM (DFT-s-OFDM) symbol. The term “slot” includes multiple consecutive symbols, e.g., 14 symbols, or 12 symbols. The term “mini-slot” includes one or more consecutive symbols, and has less symbol than a slot, e.g., 1, 2, 4, or 7 symbols.

In the context of the present disclosure, the term “WUS window” may refer to a time duration in which a terminal device is required to monitor a WUS signal. In the context of the present application, the term “DRX cycle” may refer to a long DRX cycle or a short DRX cycle or both.

As mentioned above, the beginning of a DRX cycle is semi-statically configured without considering the jitter issue of packets arrival time. This may cause a longer waiting time between arrival time of packets and a starting time of the on-duration or a longer and useless PDCCH monitoring.

In view of this, embodiments of the present disclosure provide solutions for solving the above and other potential issues. In a first aspect, there is provided a solution for starting an on-duration of a DRX cycle based on an end of reception of a WUS. In this way, a starting time of a DRX cycle may be dynamically determined, and a good tradeoff between latency and power consumption may be achieved. Accordingly, latency may be reduced and power consumption may also be reduced.

In a second aspect, a trigger signal (also referred to as a low power WUS (LP WUS) herein) is introduced to activate a search space set group (SSSG) or trigger a SSSG switching, i.e., to fully wake up a terminal device from a low power mode in which the terminal device is not required to monitor downlink control information (DCI) for scheduling. In other words, the terminal device may stay in the low power mode in which the terminal device is required to monitor the trigger signal at an earlier stage of an on-duration, and may be shifted, in response to the trigger signal, to a data transmission mode in which the terminal device is required to monitor the ordinary PDCCH (e.g., the PDCCH for scheduling) and perform the corresponding PDSCH reception or PUSCH transmission. As the low power WUS may consume less power than the ordinary PDCCH monitoring, power consumption may be reduced.

In a third aspect, a solution is provided for determining, based on a timer associated with DRX, a SSSG to be used upon starting an on-duration of a DRX cycle. In this way, unnecessary SSSG switching may be avoided and power consumption may be reduced.

Embodiments of the present disclosure may be applied to any suitable scenarios. For example, embodiments of the present disclosure may be implemented for XR. Alternatively, embodiments of the present disclosure can be implemented in one of the followings: reduced capability NR devices, NR multiple-input and multiple-output (MIMO), NR sidelink enhancements, NR systems with frequency above 52.6 GHZ, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity:

Principles and implementations of the present disclosure will be described in detail below with reference to the figures.

### Example of Communication Network

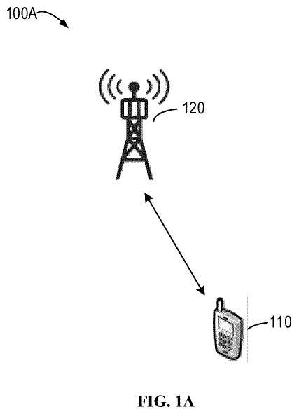

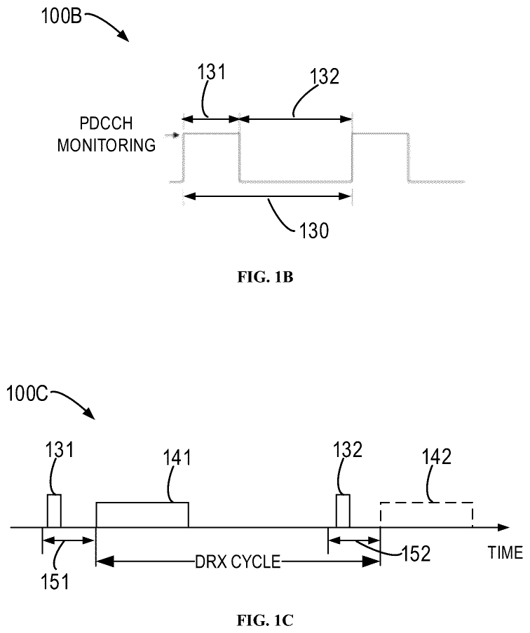

FIG. 1A illustrates a schematic diagram of an example communication network 100A in which some embodiments of the present disclosure can be implemented. As shown in FIG. 1A, the communication network 100A may include a terminal device 110 and a network device 120. In some embodiments, the terminal device 110 may be served by the network device 120. It is to be understood that the numbers of terminal devices and network devices in FIG. 1 are given for the purpose of illustration without suggesting any limitations to the present disclosure. The communication network 100A may include any suitable number of network devices and/or terminal devices adapted for implementing implementations of the present disclosure.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may transmit a configuration of DRX cycle to the terminal device 110. In this case, the terminal device 110 may perform a downlink channel monitoring based on the configuration of DRX cycle. FIG. 1B illustrates a schematic diagram 100B illustrating an example operation in a DRX cycle. As shown in FIG. 1B, a DRX cycle 130 comprises active time 131 (i.e., on-duration) and inactive time 132 (i.e., an opportunity for DRX). The terminal device 110 performs a downlink channel monitoring such as a PDCCH monitoring only in the active time 131. The inactive time may mean time other than the active time.

A timeline of DRX may mainly depend on the following parameters.
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new uplink (UL) or downlink (DL) transmission for the medium access control (MAC) entity;
drx-LongCycleStartOffset: the Long DRX cycle and drx-StartOffset which defines the subframe where the long and short DRX cycle starts;
drx-ShortCycle (optional): the short DRX cycle
drx-ShortCycleTimer (optional): the duration a terminal device shall follow the short DRX cycle;
ps-Wakeup (optional): the configuration to start associated drx-onDurationTimer in case DCP is monitored but not detected. DCP refers to DCI with cyclic redundancy check (CRC) scrambled by power saving-radio network temporary identifier (PS-RNTI).

In some scenarios, a network device may transmit a configuration of WUS detection to a terminal device. In some embodiments, the configuration of WUS detection may comprise an offset (for example, ps-Offset) from a starting time of on-duration and a duration of WUS detection. In this way, a WUS window is configured. One or more WUS occasions may be configured within the WUS window, and each WUS occasion may occupy one or more OFDM symbols. Then the terminal device may perform WUS detection in each WUS occasion based on the configuration of WUS detection, and start on-duration of a DRX cycle when a WUS is detected. FIG. 1C illustrates a schematic diagram 100C illustrating an example operation of on-duration in a DRX cycle with WUS detection.

As shown in FIG. 1C, based on a configuration of a DRX cycle, a terminal device may determine a starting time of on-duration 141, and based on a configuration of WUS detection, the terminal device may start WUS detection at a time earlier than the starting time of the on-duration 141 by an offset 151. When a WUS 131 is detected and the WUS 131 indicates to start the on-duration 141 (i.e., the WUS 131 is a positive WUS), the terminal device may start the on-duration 141 (for example, start the drx-onDurationTimer) at the starting time of the on-duration 141.

Similarly, based on a configuration of a DRX cycle, a terminal device may determine a starting time of on-duration 142, and based on a configuration of WUS detection, the terminal device may start WUS detection at a time earlier than the starting time of the on-duration 142 by an offset 152. When a WUS 132 is detected and the WUS 132 indicates to not start the on-duration 142 (for example, not start the drx-onDurationTimer), the terminal device may keep sleep.

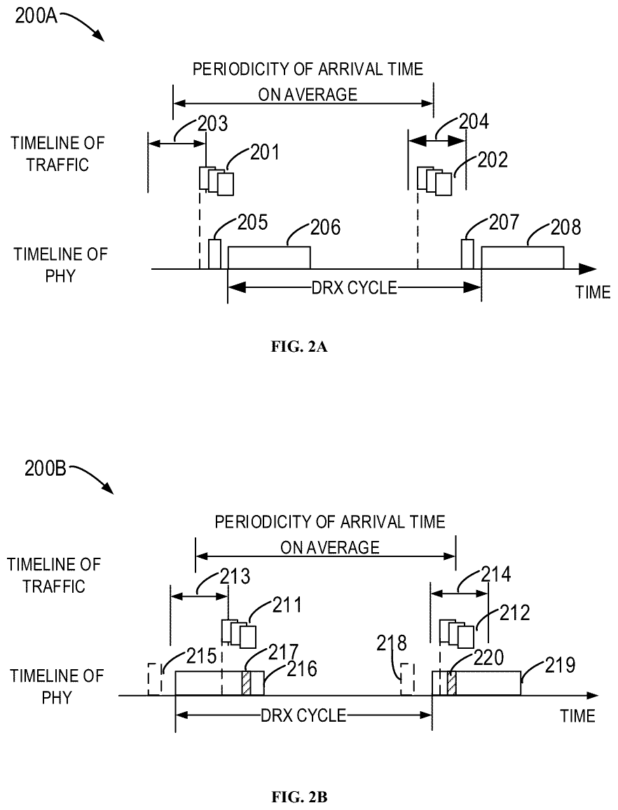

It can be seen that a WUS window is configured before the on-duration, and one or more WUS occasions in the WUS window should be detected. If a positive WUS is detected (no matter in which WUS occasion), the on-duration will be started at the beginning of the DRX cycle. However, the beginning of DRX cycle is semi-statically configured without considering jitter of packets arrival time. The details will be described below with reference to FIGS. 2A and 2B.

FIG. 2A illustrates a schematic diagram 200A illustrating an example scenario of DRX with jitter of packets. Assuming that a periodicity of arrival time on average is 16.67 ms. It is to be understood that the periodicity may take any other suitable values. In this example, assuming that a network device may configure a DRX cycle to be started after the latest time of a range of jitter.

As shown in FIG. 2A, packets 201 may arrive at the end of a range of jitter 203. When a WUS 205 indicating to start on-duration is detected or received, on-duration 206 of a DRX cycle will be started at a configured starting time of the on-duration 206. In this case, the on-duration 206 may be started in a short time after the arrival of the packets 201. Then the packets 201 may be transmitted with a short latency.

Subsequently, packets 202 may arrive at the beginning of a range of jitter 204 after a periodicity: After a long time, a WUS 207 indicating to start on-duration is detected or received. Then on-duration 208 of a DRX cycle is started at a configured starting time of the on-duration 208. In this case, the on-duration 208 may be started in a long time after the arrival of the packets 202. Then a long latency may be caused.

FIG. 2B illustrates a schematic diagram 200B illustrating another example scenario of DRX with jitter of packets. Assuming that a periodicity of arrival time on average is 16.67 ms. It is to be understood that the periodicity may take any other suitable values. In this example, assuming that a network device may configure a DRX cycle to be started before or slightly after the earliest time of a range of jitter.

As shown in FIG. 2B, A WUS 215 may be detected before the earliest time of a range of jitter 213. If the WUS 215 indicates to start on-duration, on-duration 216 will be started at a configured starting time. That is, a PDCCH monitoring may be started slightly after the earliest time of the range of jitter 213. However, packets 211 may arrive at the end of the range of jitter 213. Then PDCCH 217 may be detected when a long time after PDCCH monitoring pasts.

Subsequently, a WUS 218 may be detected before the earliest time of a range of jitter 214. If the WUS 218 indicates to start on-duration, on-duration 219 will be started at a configured starting time. That is, a PDCCH monitoring may be started slightly after the earliest time of the range of jitter 214. As shown in FIG. 2B, packets 212 may arrive at the beginning of the range of jitter 214 after a periodicity. Then PDCCH 220 may be detected in a short time after PDCCH monitoring.

It can be seen that, if on-duration is configured properly, packets may be transmitted soon after the packets arrives. However, if no packets are delivered to RAN, it is not possible to prepare a negative WUS to keep the terminal device sleeping. Further, as the arrival time of packets is unpredictable, the terminal device may need a longer and useless PDCCH monitoring time, for example, for the on-duration 217. This will cause more power consumption.

In view of the above, embodiments of the present disclosure provide solutions for DRX to overcome the above and other potential issues. With the solutions, a good tradeoff between power saving and delay reduction may be obtained, and the length of WUS window and on-duration may be as short as possible. Meanwhile, the scheduling DCI may be able to transmit as early as possible after the packet arriving.

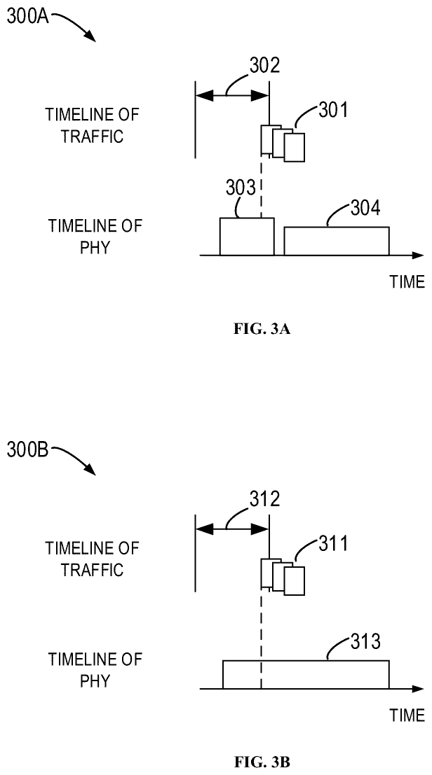

Specifically, some solutions according to embodiments of the present disclosure may be provided based on an assumption that a WUS window before on-duration may be used. FIG. 3A illustrates a schematic diagram 300A illustrating an example in which a WUS window before on-duration is configured. As shown in FIG. 3A, packets 301 may arrive at the end of a range of jitter 302. WUS window 303 may be started slightly after the earliest time of the range of jitter 302, and ended not early than the end of the range of jitter 302. For example, if the range of jitter 302 is 8 ms, the WUS window 303 may start at 2 ms after the earliest time of the range of jitter 302, and then end at the latest time of the range of jitter 302. In this case, a 6 ms WUS window is configured. However, if the packet arrives early in the WUS window; e.g., at the first 1 ms of the WUS window; a relatively long waiting time is needed to start the on-duration, which may be not acceptable for traffic with stringent packet delay budget (PDB), e.g., <10 ms.

Some solutions according to embodiments of the present disclosure may be provided based on an assumption that a WUS may be not configured and a relatively long on-duration is configured. FIG. 3B illustrates a schematic diagram 300B illustrating an example in which a WUS is not configured. As shown in FIG. 3B, packets 311 may arrive at the end of a range of jitter 312. On-duration 313 may be started slightly after the earliest time of the range of jitter 312. The on-duration 313 may be configured with a relatively long duration. In this case, a long active time may be needed and a long PDCCH monitoring time may also be needed.

It is to be understood that these assumptions are merely for illustration, and are not intended to limit these solutions. These solutions may be applied to any suitable scenarios. The details of these solutions will be described in detail below.

### Example Implementation of DRX Considering WUS

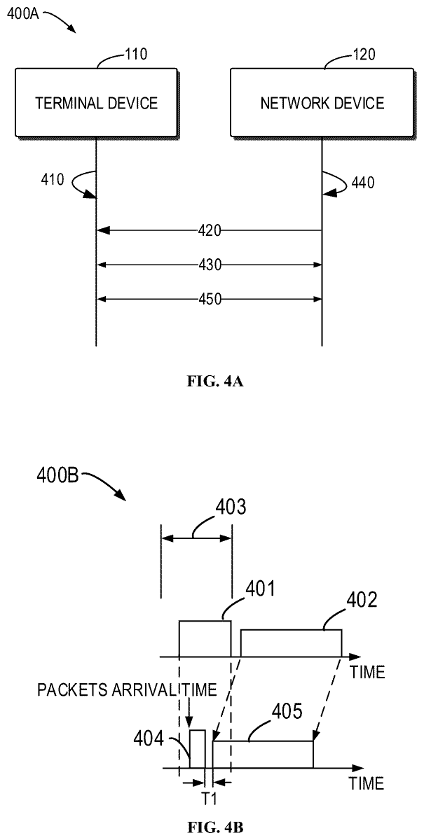

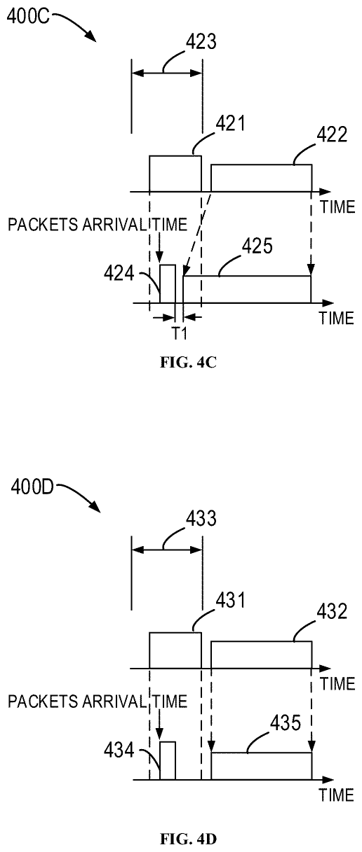

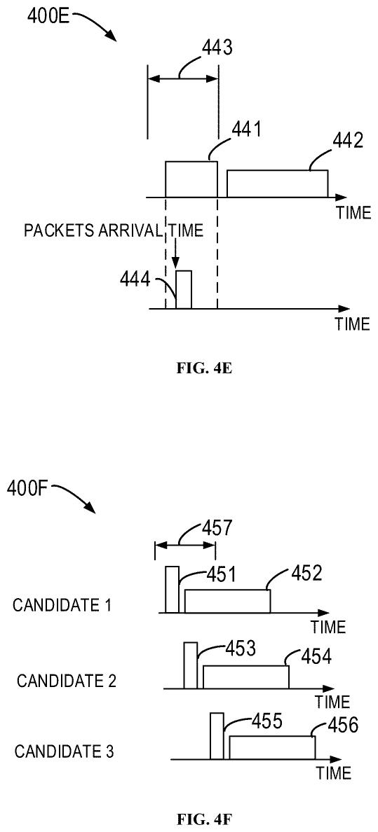

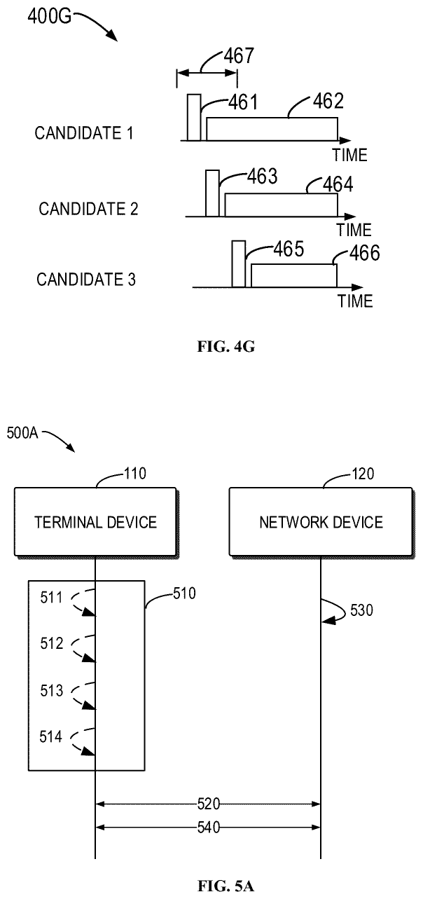

This solution is based on the assumption as described in FIG. 3A that a WUS window before on-duration may be used. In this solution, an on-duration operation of DRX is started based on an end of reception of a WUS. Some example embodiments of this solution will be detailed with reference to FIGS. 4A to 4G.

### Embodiment 1

FIG. 4A illustrates a schematic diagram illustrating a process 400A for communication according to embodiments of the present disclosure. For the purpose of discussion, the process 400A will be described with reference to FIG. 1. The process 400A may involve the terminal device 110 and the network device 120 as illustrated in FIG. 1.

As shown in FIG. 4A, the terminal device 110 determines 410 a time window for monitoring a WUS from the network device 120. In some embodiments, the terminal device 110 may receive a configuration for DRX (for convenience, also referred to as a first configuration herein) from the network device 120. In some embodiments, the configuration for DRX may comprise at least one of a start offset, a slot offset, or a length for a DRX cycle. In some embodiments, the configuration for DRX may also comprise at least one of a time offset from a starting time of a DRX cycle or a duration configured for a WUS monitoring (i.e., a length of a WUS window). Of course, the configuration for DRX may also comprise any other suitable information.

In some embodiments, the terminal device 110 may determine a starting time of an on-duration operation based on the configuration of DRX. The determined starting time may also be called as a reference starting time herein as the determined starting time may be not the actual starting time of the on-duration operation. Based on the reference starting time and a time offset (for convenience, also referred to as a second time offset herein and denoted as ps-Offset) from the reference starting time, the terminal device 110 may determine a starting time of the time window for WUS detection. For example, the WUS window may start from the ps-Offset before the reference starting time.

Then the terminal device 110 may determine the time window based on the starting time of the time window and a duration (denoted as Tₛ) configured for a WUS. For example, the WUS window may end after Tₛ from the beginning of the WUS window. In some embodiments, there may be a gap between the end of the WUS window and the reference stating time of the on-duration operation.

In some alternative embodiments for determination of the time window; the terminal device 110 may determine a reference value at least based on a configuration (also referred to as a second configuration) for a search space set for a WUS. In some embodiments, the terminal device 110 may receive the configuration for a search space set for a WUS from the network device 120. In some embodiments, the configuration for a search space set for a WUS may comprise a periodicity of a search space set for a WUS.

In some embodiments, the periodicity may be a non-integer value, e.g., 1000/60 ms. In some embodiments, the search space set may comprise a set of monitoring occasions for a WUS. In some embodiments, the configuration for a search space set for a WUS may also comprise a duration of a WUS.

For example, the terminal device 110 may determine the reference value by the equation (1) below:

$$R = ( {n}_{f} . {N}_{slot}^{frame , μ} + {n}_{s , f}^{μ} - {o}_{s} ) mod {k}_{s} \qquad ( 1 )$$

where R denotes the reference value, n_{f} denotes a frame number, Nₛₗₒₜ^{frame,μ} denotes the number of slots in a frame, n_{s,f}^{μ} denotes a slot number, oₛ denotes a PDCCH monitoring offset, kₛ denotes PDCCH monitoring periodicity, and mod denotes modulo operation for rational number.

Then the terminal device 110 may determine a starting time of the time window based on an operation of rounding down or up the reference value. For example, for search space set s with a PDCCH monitoring periodicity of kₛ slots and a PDCCH monitoring offset of oₛ slots, the UE determines that a PDCCH monitoring occasion(s) exists in a slot with number n_{s,f}^{μ} in a frame with number n_{f} if floor (R)=0 or ceil (R)=0.

Upon determination of the starting time of the time window; the terminal device 110 may determine the time window based on the starting time of the time window and a duration (denoted as Tₛ) configured for a WUS. For example, the WUS window may end after Tₛ from the beginning of the WUS window: In some embodiments, there may be a gap between the end of the WUS window and the reference stating time of the on-duration operation.

Upon determination of the time window; the terminal device 110 may performs WUS detection in the time window. Return to FIG. 4A, if the terminal device 110 receives 420 a WUS from the network device 120 in the time window; the terminal device 110 starts 430 an on-duration operation of DRX based on a time offset (denoted as T1 and also referred to as a first time offset herein for convenience) from an end of the reception of the WUS. In some embodiments, if the WUS indicates to start the on-duration operation, the terminal device 110 may start the on-duration operation based on the time offset T1 from the end of the reception of the WUS.

For example, the terminal device 110 may start the on-duration operation of DRX after the time offset T1 from the end of the reception of the WUS.

In some embodiments, the terminal device 110 may start the on-duration operation in a starting time unit after the time offset T1 from an end of a time unit in which the WUS is received. In some embodiments, the time unit may be a slot, and the starting time unit may be the first slot. In some embodiments, the time unit may be a symbol, and the starting time unit may be the first symbol. In some embodiments, the time unit may be a sub-slot, and the starting time unit may be the first sub-slot.

In some embodiments, the time offset T1 may be predefined or preconfigured. For example, the time offset T1 may be associated with a capability or preference of the terminal device 110.

In some embodiments, the time offset T1 may be indicated by the WUS. In these embodiments, the terminal device 110 may obtain an indication (also referred to as a first indication herein for convenience) of the time offset T1 from the WUS and determine the time offset T1 based on the indication. For example, the terminal device 110 may determine the time offset T1 from a configured set of candidate values based on the indication. In some embodiments, the time offset T1 may be zero. Of course, the time offset T1 may be any other suitable values.

In some embodiments, the WUS may be a group common signal (e.g., a group common PDCCH). In this case, the time offset T1 may be also group common. In these embodiments, the WUS may include multiple wake-up indications for multiple terminal devices, and a value of the time Offset T1 to be applied for the multiple wake-up indications.

In the context of the present disclosure, the term “on-duration operation” may refer to a downlink channel monitoring such as a PDCCH monitoring or a data transmission such as PDSCH or PUSCH transmission. The data transmission may comprise at least one of sending data or receiving data. In some embodiments, the terminal device 110 may start an on-duration timer such as drx-onDurationTimer to start the on-duration operation.

In some embodiments, the terminal device 110 may determine a duration of the on-duration operation based on the configuration for DRX. In other words, the terminal device 110 may determine a length of the on-duration timer based on the configuration for DRX. Comparing with the current specification, the length of on-duration of a DRX cycle keeps unchanged. FIG. 4B illustrates a schematic diagram 400B illustrating an example on-duration operation in the process of FIG. 4A according to embodiments of the present disclosure. As shown in FIG. 4B, a WUS window 401 is started slightly after the earliest time of the range of jitter 403, and ended not early than the end of the range of jitter 403. Based on the configuration for DRX, on-duration 402 may be configured to be started after the WUS window 401. When a WUS 404 is detected, on-duration 405 may be started at T1 from the end of the reception of the WUS 404. In other words, the on-duration 402 is shifted to be stated at T1 from the end of the reception of the WUS 404.

In some embodiments, the terminal device 110 may determine a duration of the on-duration operation based on the configuration for DRX and a predetermined duration (denoted as delta). For example, the terminal device 110 may determine an original length (denoted as TO) of an on-duration timer based on the configuration of DRX and determine a final length of the on-duration timer to be T0+delta. This is beneficial for multi-flow traffic (e.g., video+audio, I-frame+P-frame, data+control) with different arrival time of each flow; since some of the traffic flows may arrives at a later time in the original on-duration.

In some embodiments, the predetermined duration may be associated with the position of the detected WUS in the WUS window. In some embodiments, the terminal device 110 may determine the predetermined duration based on the reference starting time of the on-duration operation and the actual starting time of the on-duration operation. For example, the predetermined duration may be determined by equation (2) below.

$$delta = T 3 - T 2 \qquad ( 2 )$$

where delta denotes the predetermined duration, T3 denotes the reference starting time of the on-duration, and T2 denotes the actual starting time of the on-duration. In other words, delta may be the time difference between the reference starting time of the on-duration and the actual starting time of the on-duration. It is to be understood that the above equation is merely an example, any other suitable ways are also feasible.

In some embodiments, the terminal device 110 may determine the predetermined duration based on the remaining length of the time window after the end of the reception of the WUS. For example, the predetermined duration may be determined by equation (3) below.

$$delta = T 4 \qquad ( 3 )$$

where delta denotes the predetermined duration, T4 denotes the remaining length of the time window after the end of the reception of the WUS. It is to be understood that the above equation is merely an example, any other suitable ways are also feasible.

In some embodiments, the terminal device 110 may determine the predetermined duration based on the remaining length of the time window after an end of a slot in which the WUS is received. For example, the predetermined duration may be determined by equation (4) below.

$$delta = T 5 \qquad ( 4 )$$

where delta denotes the predetermined duration, T5 denotes the remaining length of the time window after an end of a slot in which the WUS is received. It is to be understood that the above equation is merely an example, any other suitable ways are also feasible.

In some embodiments, the terminal device 110 may determine the predetermined duration based on an indication (for convenience, also referred to as a second indication herein) of the predetermined duration from the network device 120. For example, the indication of the predetermined duration may be carried in the WUS. As another example, the indication of the predetermined duration may be transmitted in a RRC pre-configuration.

FIG. 4C illustrates a schematic diagram 400C illustrating another example on-duration operation in the process of FIG. 4A according to embodiments of the present disclosure. As shown in FIG. 4C, a WUS window 421 is started slightly after the earliest time of the range of jitter 423, and ended not early than the end of the range of jitter 423. Based on the configuration for DRX, on-duration 422 may configured to be started after the WUS window 421. When a WUS 424 is detected, on-duration 425 may be started at T1 from the end of the reception of the WUS 424 and ended at the original ending time determined based on the configuration for DRX. In other words, the on-duration 422 is early started before the reference starting time of the on-duration.

In some alternative embodiments, if the terminal device 110 detects the WUS, the terminal device 110 may start the on-duration operation at the reference starting time. FIG. 4D illustrates a schematic diagram 400D illustrating another example on-duration operation in the process of FIG. 4A according to embodiments of the present disclosure. As shown in FIG. 4D, a WUS window 431 is started slightly after the earliest time of the range of jitter 433, and ended not early than the end of the range of jitter 433. Based on the configuration for DRX, on-duration 432 may be configured to be started after the WUS window 431. When a WUS 434 is detected, on-duration 435 may be started at the original starting time (i.e., the reference starting time as described above) determined based on the configuration for DRX and ended at the original ending time determined based on the configuration for DRX.

In some embodiments, the WUS may indicate to not start the on duration operation. In these embodiments, the terminal device 110 may keep sleeping and not start the on-duration. FIG. 4E illustrates a schematic diagram 400E illustrating another example on-duration operation in the process of FIG. 4A according to embodiments of the present disclosure. As shown in FIG. 4E, a WUS window 441 is started slightly after the earliest time of the range of jitter 443, and ended not early than the end of the range of jitter 443. Based on the configuration for DRX, on-duration 442 may be configured to be started after the WUS window 441. When a WUS 444 is detected, the on-duration 442 is not started.

In some embodiments, the WUS may indicate one of the above solutions as described in connection with FIGS. 4B to 4E with two information bits.

In some embodiments, the terminal device 110 may not receive a WUS from the network device 120. For example, the terminal device 110 may not successfully detect a WUS. As another example, the terminal device 110 may not have available monitoring occasions in the time window; e.g., all monitoring occasions in the time window collide with monitoring or receiving of other signal or collide with uplink symbols. In these embodiments, if the terminal device 110 does not receive a WUS, the terminal device 110 may start the on-duration operation at the reference starting time. As an alternative, if the terminal device 110 does not receive a WUS, the terminal device may not start the on-duration operation. In these embodiments, whether to start or not start the on-duration operation may be indicated by a RRC configuration.

Return to FIG. 4A, the network device 120 determines 440 the time window in similar way as the determination 410 of the terminal device 110. In response to transmitting 420 the WUS, the network device 120 starts 450 an on-duration operation of DRX based on a time offset from an end of the reception of the WUS. The operation of the starting 450 is similar to the operation of the starting 430. Thus, the operations of the determination 440 and the starting 450 are not repeated here for concise.

In this way, a starting time of a DRX cycle may be dynamically determined, and a good tradeoff between latency and power consumption may be achieved. Accordingly, latency may be reduced and power consumption may also be reduced.

### MODIFICATION

This embodiment is a modification to Embodiment 1. In Embodiment 1, the reference starting time may be uniquely determined based on the configuration for DRX. In the Modification, multiple reference starting times of the on-duration operation may be determined based on the configuration for DRX. For example, the network device 120 may configure multiple DRX start offset values for the terminal device 110 and the terminal device 110 may determine the multiple reference starting times based on the multiple DRX start offset values.

In some embodiments, only one on-duration timer may be configured, and the multiple reference starting times may be associated with this on-duration timer. FIG. 4F illustrates a schematic diagram 400F illustrating an example of multiple time windows associated with a single on-duration timer according to embodiments of the present disclosure. As shown in FIG. 4F, three configurations for time windows are configured, i.e., CANDIDIATE 1, CANDIDATE 2 and CANDIDATE 3. In CANDIDATE 1, a WUS window 451 is associated with on-duration 452. In CANDIDATE 2, a WUS window 453 is associated with on-duration 454. In CANDIDATE 3, a WUS window 455 is associated with on-duration 456. The time windows 451, 453 and 455 may be started slightly after the earliest time of the range of jitter 457, and ended not early than the end of the range of jitter 457. The on-durations 452, 454 and 456 have the same duration. In other words, the time windows 451, 453 and 455 may be associated with the same on-duration timer.

In some embodiments, multiple on-duration timers may be configured, and each of the multiple reference starting times may be associated with an on-duration timer in the multiple on-duration timers. In some embodiments, the end of the multiple on-duration timers may be aligned with each other. FIG. 4G illustrates a schematic diagram 400G illustrating an example of multiple time windows associated with multiple on-duration timers according to embodiments of the present disclosure. As shown in FIG. 4G, three configurations for time windows are configured, i.e., CANDIDIATE 1, CANDIDATE 2 and CANDIDATE 3. In CANDIDATE 1, a WUS window 461 is associated with on-duration 462. In CANDIDATE 2, a WUS window 463 is associated with on-duration 464. In CANDIDATE 3, a WUS window 465 is associated with on-duration 466. The time windows 461, 463 and 465 may be started slightly after the earliest time of the range of jitter 467, and ended not early than the end of the range of jitter 467. The on-durations 462, 464 and 466 have different durations but are aligned at the end of these on-durations. In other words, the time windows 461, 463 and 465 may be associated with multiple on-duration timers.

Then the terminal deice 110 may determine multiple starting times for multiple time windows based on the multiple reference starting times of the on-duration operation and a time offset (for convenience, also referred to as a third time offset herein) from the multiple reference starting times. In other words, each of the multiple time windows is associated with a reference starting time in the multiple reference starting times.

In some embodiments, the terminal deice 110 may determine multiple starting times for multiple time windows based on the multiple reference starting times of the on-duration operation and multiple time offsets from the multiple reference starting times. In some embodiments, the terminal device 110 may determine the multiple time windows based on the multiple starting times and multiple durations configured for the multiple time windows. For example, the terminal device 110 may determine each time window based on a ps-Offset value and a duration value configured for the time window.

In some embodiments, the terminal device 110 may determine the multiple time windows based on the multiple starting times and one duration configured for the multiple time windows. In other words, the multiple time windows are associated with the same ps-Offset and same duration values configured for the WUS.

Upon determination of the multiple time windows, the terminal device 110 may monitor WUS in the multiple time windows. In some embodiments, if a time window is overlapped with the next time window; the time window may be ended before the start of the next time window: In other words, the terminal device 110 may stop to monitor WUS in this time window after the start of the next time window:

In some embodiments, if the terminal device 110 receives a WUS in a time window (for convenience, also referred to as a first time window herein) of the multiple time windows, the terminal device 110 may start the on-duration operation at a first reference starting time of the multiple reference starting times, wherein the first reference starting time is associated with the first time window: In some embodiments, if the WUS indicates to start the on-duration operation, the terminal device 110 may start the on-duration operation at a first reference starting time of the multiple reference starting times, wherein the first reference starting time is associated with the first time window: In some embodiments, if the WUS indicates to not start the on-duration operation, the terminal device 110 may not start the on-duration operation.

In some embodiments, if the terminal device 110 receives a WUS in a time window of the multiple time windows, the terminal device 110 may stop monitoring WUS in remaining time windows of the multiple time windows. For example, if the terminal device 110 successfully detects a WUS in a time window; the terminal device 110 may start an on-duration timer at a starting time associated with the time window; and stop monitor WUS in the remaining time windows.

In this way, a starting time of a DRX cycle may be dynamically determined, and a good tradeoff between latency and power consumption may be achieved. Accordingly, latency may be reduced and power consumption may also be reduced.

### Example Implementation of DRX Considering LP WUS

Considering that packets may arrive within an on-duration at an unpredictable time, embodiments of the present disclosure proposes introducing a trigger signal (also referred to as LP WUS herein) to fully wake up a terminal device from a low power mode. The low power mode may refer to a mode that a terminal device is required to monitor a trigger signal and may not be required to monitor scheduling DCI. The scheduling DCI may refer to a DCI format with CRC scrambled by a cell-radio network temporary identifier (C-RNTI). A network device may configure at least two SSSGs, one (denoted as SSSG0) is used from the beginning of the on-duration which includes a search space set for LP WUS, and another (denoted as SSSG1) is used for normal DL/UL scheduling.

SSSG0 may be denser but with lower power consumption, e.g., need less blind decoding or using a sequence based LP WUS. SSSG1 may be sparser but need more power consumption, e.g., with normal DCI format (e.g., format 0-1, format 1-1) and high blind decoding complexity: If a terminal device detects a LP WUS, or if a terminal device receive a switching indication (e.g., by a DCI), the SSSG is switched from SSSG0 to SSSG1.

The LP WUS may refer to a signal used to activate a SSSG or a timer or trigger a SSSG switching. The SSSG switching may be used to enable the terminal device to switch from the low power mode to a data transmission mode. The LP WUS may consume less power than the ordinary PDCCH monitoring, e.g., need less blind decoding attempts and low detect or decode complexity.

In some embodiments, the LP WUS may be a sequence based signal. In this way, low power may be achieved. In some embodiments, a control channel element (CCE) aggregation level may be designed to achieve low power. In some embodiments, a control resource set (CORESET) size may be designed to achieve low power.

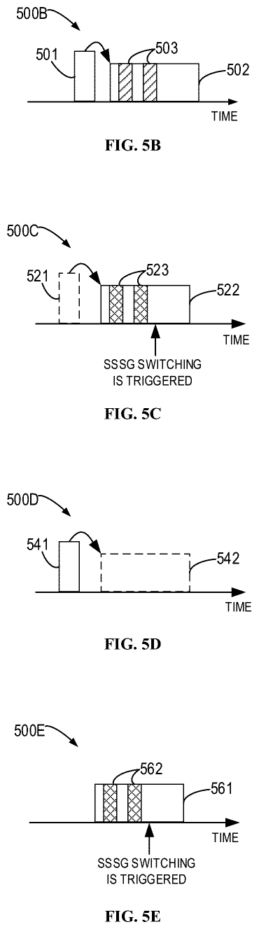

In some embodiments, a WUS may still be used before an on-duration as described in FIG. 3A, and its function can be enhanced for flexibility and backward compatibility. In some embodiments, the WUS may also not be used as described in FIG. 3B. Some example embodiments of this solution will be detailed with reference to FIGS. 5A to 5E.

FIG. 5A illustrates a schematic diagram illustrating another process 500A for communication according to embodiments of the present disclosure. For the purpose of discussion, the process 500A will be described with reference to FIG. 1. The process 500A may involve the terminal device 110 and the network device 120 as illustrated in FIG. 1.

As shown in FIG. 5A, the terminal device 110 determines 510 a target SSSG from a configured set of SSSGs, the configured set of SSSGs comprising a search space set for monitoring a trigger signal used to activate a SSSG or trigger a SSSG switching. For example, the terminal device 110 may receive, from the network device 120, a configuration indicating the configured set of SSSGs. For example, the configured set of SSSGs may comprise SSSG0 as described above. Of course, the configured set of SSSG may also comprise any other suitable SSSGs, for example, SSSG1. In some embodiments, the number of SSSG0 in the configured set of SSSGs may be 1, 2, 3 or any other values. In some embodiments, the number of SSSG1 in the configured set of SSSGs may be 1, 2, 3 or any other values.

In some embodiments, the terminal device 110 may determine 511 whether a time window for WUS detection is configured. If the time window is configured, the terminal device 110 may determine 512 whether a WUS is detected in the time window: If the WUS is detected, the terminal device 110 may determine 513 whether the WUS indicates to start an on-duration operation of DRX. If the WUS indicates to start the on-duration operation, the terminal device 110 may determine 514, as the target SSSG, a SSSG (for convenience, also referred to as a first SSSG herein) in the configured set of SSSGs that does not comprise the search space set for monitoring the trigger signal.

Upon determination of the target SSSG, the terminal device 110 starts an on-duration operation of DRX based on the target SSSG. For example, the terminal device 110 may start PDCCH monitoring based on the configuration of the target SSSG.

The network device 120 also determines 530 the target SSSG in similar way as the determination 510 of the terminal device 110. Thus, the operations of the determination 530 are not repeated here for concise. Upon determination of the target SSSG, the network device 120 starts 540 an on-duration operation of DRX based on the target SSSG. For example, the network device 120 may perform data transmission based on the configuration of the target SSSG.

For illustration, some example embodiments for determination of the target SSSG will be described with reference to FIGS. 5B to 5E.

FIG. 5B illustrates a schematic diagram 500B illustrating an example on-duration operation in the process of FIG. 5A according to embodiments of the present disclosure.

As shown in FIG. 5B, if a WUS 501 indicating to start an on-duration 502 is detected, the terminal device 110 may start the on-duration with SSSG 503. The SSSG 503 does not comprise the search space set for monitoring the trigger signal. For example, the SSSG 503 may be SSSG1 as described above.

In some embodiments, the SSSG 503 (i.e., the first SSSG) may be predefined or preconfigured. In other words, an SSSG (e.g., SSSG1) is preconfigured (e.g., by RRC information) or pre-defined to be the active SSSG in the beginning of on-duration on the condition that a WUS is detected and the WUS indicates to start the on-duration.

In some embodiments, the terminal device 110 may obtain information of the SSSG 503 from the WUS 501, and determine the SSSG 503 from the configured set of SSSGs based on the information of the SSSG 503. In other words, the WUS 501 may indicate a SSSG from the configured set of SSSGs to be the active SSSG in the beginning of on-duration for the next DRX cycle.

In some embodiments, the terminal device 110 may determine a candidate set of SSSGs (for convenience, also referred to as a first candidate set of SSSGs herein) from the configured set of SSSGs, each SSSG in the candidate set of SSSGs comprising no search space set for monitoring the trigger signal. Then the terminal device 110 may determine, as the SSSG 503, a SSSG having the lowest index in the candidate set of SSSGs. In other words, the terminal device 110 may determine the active SSSG based on whether the SSSG comprises a search space set for LP WUS monitoring. In this case, the active SSSG should be an SSSG without a search space set for LP WUS monitoring. If there are multiple SSSGs without a search space set for LP WUS monitoring, the one with the lowest SSSG ID is determined as the active SSSG.

In some embodiments, a WUS may not be detected in the time window: This may means that the terminal device 110 mis-detects the WUS or the network device 120 does not transmit the WUS. In these embodiments, the terminal device 110 may determine a SSSG (for convenience, also referred to as a second SSSG herein) from the configured set of SSSGs that comprises the search space set for monitoring the trigger signal.

FIG. 5C illustrates a schematic diagram 500C illustrating another example on-duration operation in the process of FIG. 5A according to embodiments of the present disclosure. As shown in FIG. 5C, monitoring of a WUS 521 is configured to the terminal device 110, but the WUS 521 is not detected by the terminal device 110. In this case, the terminal device 110 may start the on-duration with SSSG 523. The SSSG 523 comprises the search space set for monitoring the trigger signal. For example, the SSSG 523 may be SSSG0 as described above.

In some embodiments, the SSSG 523 (i.e., the second SSSG) may be predefined or preconfigured. In other words, an SSSG (e.g., SSSG0) is preconfigured (e.g., by RRC information) or pre-defined to be the active SSSG in the beginning of on-duration on the condition that a WUS is not detected.

In some embodiments, if a WUS is detected in the time window and the WUS indicates to not start an on-duration, the terminal device 110 may not start the on-duration and keep sleeping. FIG. 5D illustrates a schematic diagram 500D illustrating still another example on-duration operation in the process of FIG. 5A according to embodiments of the present disclosure. As shown in FIG. 5D, if a WUS 541 indicating to not start an on-duration 542 is detected, the terminal device 110 may not start the on-duration 542.

In some embodiments, if the terminal device 110 determines that the time window for WUS detection is not configured, the terminal device 110 may determine, as the target SSSG, a SSSG (i.e., the second SSSG) from the configured set of SSSGs that comprises the search space set for monitoring the trigger signal. In other words, even if WUS monitoring is not configured, the terminal device 110 will always start an on-duration.

FIG. 5E illustrates a schematic diagram 500E illustrating another example on-duration operation in the process of FIG. 5A according to embodiments of the present disclosure. As shown in FIG. 5E, if the time window for WUS detection is not configured, the terminal device 110 may start an on-duration 561 with SSSG 562. The SSSG 562 comprises the search space set for monitoring the trigger signal. For example, the SSSG 562 may be SSSG0 as described above.

In some embodiments, the SSSG 562 (i.e., the second SSSG) may be predefined or preconfigured. In other words, an SSSG (e.g., SSSG0) is preconfigured (e.g., by RRC information) or pre-defined to be the active SSSG in the beginning of on-duration on the condition that a WUS is not detected.

In this way, A good tradeoff between power saving and transmission delay for the traffic (e.g., XR) with significant jitter may be achieved.

### Example Implementation of DRX Considering SSSG Switching

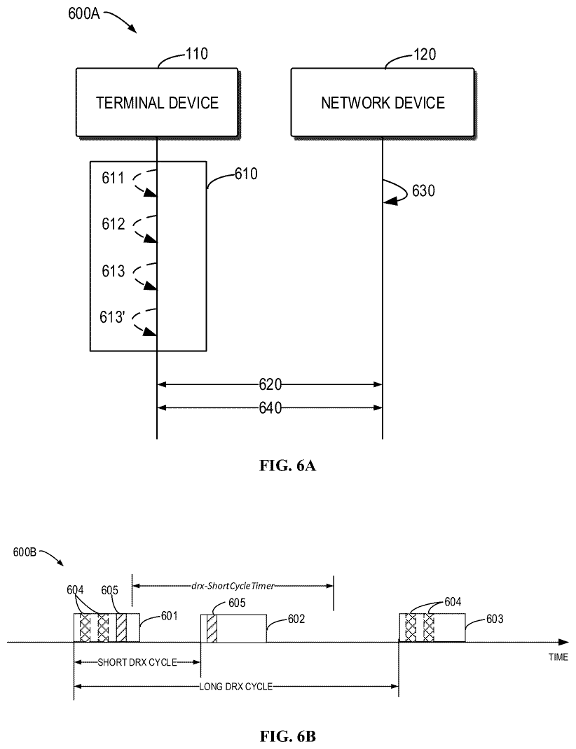

The present inventor found that if a SSSG switching occurs in a short DRX cycle, e.g., switching from SSSG0 to SSSG1, an issue may arise on whether the SSSG should be switched back to SSSG0 in the next one or more short DRX cycles. Embodiments of the present disclosure provide a solution for solving this issue or other potential issues. The details of the solution will be described with reference to FIGS. 6A and 6B.

FIG. 6A illustrates a schematic diagram illustrating still another process 600A for communication according to embodiments of the present disclosure. For the purpose of discussion, the process 600A will be described with reference to FIG. 1. The process 600A may involve the terminal device 110 and the network device 120 as illustrated in FIG. 1. In this embodiment, multiple SSSGs are configured for the terminal device 110.

As shown in FIG. 6A, if a SSSG switching from one SSSG (also referred to as a first SSSG) to another SSSG (also referred to as a second SSSG) is performed in a short DRX cycle (also referred to as a first short DRX cycle), the terminal device 110 determines 610 a SSSG from the multiple SSSGs based on a timer associated with DRX.

In some embodiments, the terminal device 110 may determine 611 whether the timer is running. If the timer is running (e.g., not stopped), the terminal device 110 may determine 612 the second SSSG as the SSSG. In other words, the terminal device 110 keep the current SSSG when the timer is still running. In some embodiments, if the timer is running and no SSSG switching indication is received, the terminal device 110 may keep the current SSSG.

In some embodiments, if the timer is not running, e.g., the timer expires or is stopped, the terminal device 110 may determine 613 the first SSSG as the SSSG. In other words, the terminal device 110 may switch back to the first SSSG when the timer expires or is stopped. In some alternative embodiments, if the timer is not running, e.g., the timer expires or is stopped, the terminal device 110 may determine 613′ a default SSSG as the SSSG.

In some embodiments, the timer associated with DRX may be a timer configured for a short DRX cycle, for example, a drx-ShortCycleTimer or any other suitable timers. Short DRX cycle can enable short time sleeping in-between transmissions. The drx-ShortCycleTimer is used to control the time that short DRX cycle is used. The drx-ShortCycleTimer is started or restarted after the drx-InactivityTimer expires or after a medium access control-control element (MAC-CE) indication, and is ended if it is not restarted again in a time duration (i.e., the timer length) or is stopped by MAC-CE indication.

In some embodiments, the timer associated with DRX may be a newly defined timer. The timer may be started when the SSSG switching occurs. The timer may be paused when the terminal device 110 is in inactive time. The timer may be resumed when the terminal device 110 is in active time. In other words, the timer only runs in the active time and is paused if it is not in the active time.

Based on the determined SSSG, the terminal device 110 starts 620 an on-duration operation of DRX in a short DRX cycle (also referred to as a second short DRX cycle herein) later than the first short DRX cycle. In other words, the terminal device 110 may start an on-duration operation of DRX in the next one or more short DRX cycles.

FIG. 6B illustrates a schematic diagram 600B illustrating an example DRX operation in the process of FIG. 6A according to embodiments of the present disclosure. In this example, the timer associated with DRX is the drx-ShortCycle Timer.

As shown in FIG. 6B, during an on-duration 601 in the earlier short DRX cycle, a SSSG switching occurs from a SSSG 604 to a SSSG 605. For the later short DRX cycle, as the drx-ShortCycleTimer is still running, the terminal device 110 may start an on-duration 602 in the later short DRX cycle with the SSSG 605. For the next long DRX cycle, as the drx-ShortCycleTimer expires, the terminal device 110 may start an on-duration 603 in the next long DRX cycle with the SSSG 607. It is to be understood that this is merely an example, and is not intended to limit the present disclosure.

In some embodiments, if the SSSG switching from the first SSSG to the second SSSG occurs in the first short DRX cycle, the terminal device 110 may always switch back to the first SSSG at the end of the first short DRX cycle. In some embodiments, how to determine the SSSG may be preconfigured. Return to FIG. 6A, if a SSSG switching occurs in a short DRX cycle, the network device 120 also determines 630 a SSSG from multiple SSSGs based on the timer associated with DRX. The operations of the determination 630 are similar with the operations of the determination 610 of the terminal device 110, and thus the details are not repeated here for concise.

Upon determination of the SSSG, the network device 120 starts 640 an on-duration operation of DRX based on the determined SSSG in the next one or more short DRX cycles. For example, the network device 120 may perform data transmission with the determined SSSG in the next one or more short DRX cycles.

With the solution of FIG. 6A, unnecessary SSSG switching may be avoided and power consumption may be reduced.

### Example Implementation of Methods

Accordingly, embodiments of the present disclosure provide methods of communication implemented at a terminal device and a network device. These methods will be described below with reference to FIGS. 7 to 12.

FIG. 7 illustrates an example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 determines a time window for monitoring a WUS from the network device 120.

In some embodiments, the terminal device 110 may determine a reference starting time of the on-duration operation based on a first configuration for DRX, and determine a starting time of the time window based on the reference starting time and a second time offset from the reference starting time. Then the terminal device 110 may determine the time window based on the starting time of the time window and a duration configured for the WUS.

In some alternative embodiments, the terminal device 110 may determine a reference value at least based on a second configuration for a search space set for the WUS, determine a starting time of the time window based on an operation of rounding down or up the reference value, and determine the time window based on the starting time of the time window and a duration configured for the WUS. Then the terminal device 110 may perform WUS detection in the time window.

At block 720, the terminal device 110 determines whether a WUS is received from the network device 120 in the time window. If the WUS is received, the process proceeds to block 730. At block 730, the terminal device 110 starts an on-duration operation of DRX based on a first time offset from an end of the reception of the WUS. For example, the terminal device 110 may start an on-duration timer at the first time offset from an end of the transmission of the WUS. Then the terminal device 110 may perform downlink channel monitoring (e.g., PDCCH monitoring) in the on-duration.

In some embodiments, the terminal device 110 may start the on-duration operation in a starting time unit after the first time offset from an end of a time unit in which the WUS is received. In some embodiments, the time unit comprises at least one of a slot, a symbol, or a sub-slot.

In some embodiments, the first time offset may be predefined or preconfigured. In some embodiments, the first time offset may be indicated by the WUS. In these embodiments, the terminal device 110 may obtain a first indication of the first time offset from the WUS, and determine the first time offset based on the first indication.

In some embodiments, the WUS may comprise multiple wake-up indications for multiple terminal devices and a value of the first time offset to be applied for the multiple wake-up indications.

In some embodiments, the terminal device 110 may determine a duration of the on-duration operation based on a first configuration for DRX. In some embodiments, the terminal device 110 may determine a duration of the on-duration operation based on the first configuration for DRX and a predetermined duration. In some embodiments, the terminal device 110 may determine the predetermined duration based on a reference starting time of the on-duration operation and the time of the starting the on-duration operation, the reference starting time being determined based on the first configuration for DRX. In some embodiments, the terminal device 110 may determine the predetermined duration based on the remaining length of the time window after the end of the reception of the WUS. In some embodiments, the terminal device 110 may determine the predetermined duration based on the remaining length of the time window after an end of a slot in which the WUS is received. In some embodiments, the terminal device 110 may determine the predetermined duration based on a second indication of the predetermined duration from the network device 120.

In some embodiments, in response to receiving no WUS from the network device 120 in the time window; the terminal device 110 may start the on-duration operation of DRX at a reference starting time of the on-duration operation, the reference starting time being determined based on a first configuration for DRX. For example, the terminal device 110 may start an on-duration timer at the reference starting time. Then the terminal device 110 may perform downlink channel monitoring (e.g., PDCCH monitoring) in the on-duration.

In some embodiments, the terminal device 110 may determine multiple reference starting times of the on-duration operation based on a first configuration for DRX, determine multiple starting times for multiple time windows based on the multiple reference starting times and a third time offset from the multiple reference starting times, and determine, as the time window, the multiple time windows based on the multiple starting times and one or multiple durations configured for the multiple time windows. In some embodiments, the multiple starting times may be associated with an on-duration timer. In some alternative embodiments, each of the multiple starting times may be associated with one of multiple on-duration timers.

In some embodiments, in response to receiving the WUS in a first time window of the multiple time windows, the terminal device 110 may start the on-duration operation at a first reference starting time of the multiple reference starting times, the first reference starting time being associated with the first time window. In some embodiments, in response to receiving the WUS in a first time window of the multiple time windows, the terminal device 110 may stop monitoring of the WUS in remaining time windows of the multiple time windows.

With the method of FIG. 7, a starting time of a DRX cycle may be dynamically determined, and a good tradeoff between latency and power consumption may be achieved. Accordingly, latency may be reduced and power consumption may also be reduced.

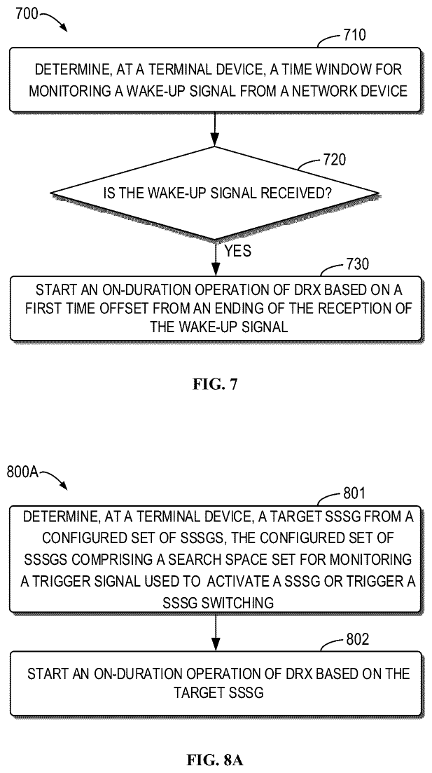

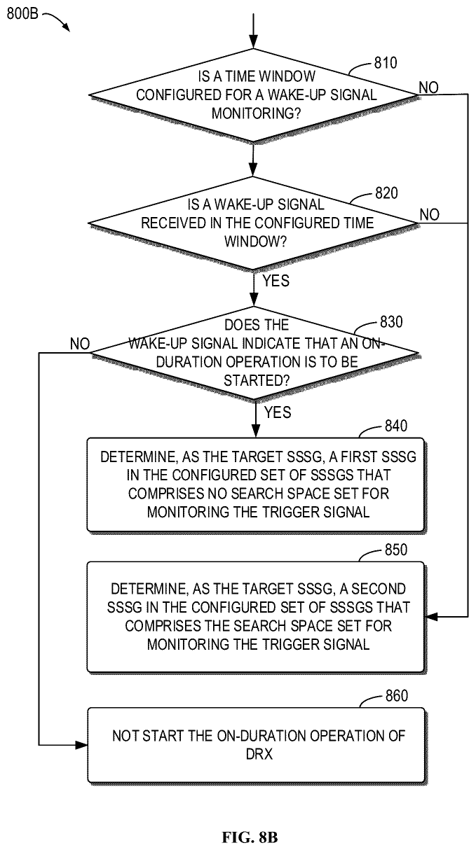

FIG. 8A illustrates an example method 800A of communication implemented at a terminal device in accordance with some embodiments of the present disclosure. For example, the method 800A may be performed at the terminal device 110 as shown in FIG. 1. For the purpose of discussion, in the following, the method 800A will be described with reference to FIG. 1. It is to be understood that the method 800A may include additional blocks not shown and/or may omit some blocks as shown, and the scope of the present disclosure is not limited in this regard.

At block 801, the terminal device 110 determines a target SSSG from a configured set of SSSGs, the configured set of SSSGs comprising a search space set for monitoring a trigger signal used to activate a SSSG or trigger a SSSG switching. In some embodiments, the terminal device 110 may select the target SSSG from the configured set of SSSGs based on a configuration of a time window and a reception of a WUS. In some embodiments, the target SSSG may comprise the search space set for monitoring the trigger signal. In some embodiments, the target SSSG may not comprise the search space set for monitoring the trigger signal.

At block 802, the terminal device 110 starts an on-duration operation of DRX based on the target SSSG. For example, the terminal device may start an on-duration timer with the target SSSG. Then the terminal device 110 may perform downlink channel monitoring (e.g., PDCCH monitoring) in the on-duration with the target SSSG.

In this way, a trigger signal is introduced to fully wake up a terminal device from a low power mode in which the terminal device is not required to monitor scheduling DCI. Thereby, power consumption may be reduced. For illustration, some example embodiments will be further described with reference to FIG. 8B.

FIG. 8B illustrates an example method 800B of starting an on-duration operation of DRX implemented at a terminal device in accordance with some embodiments of the present disclosure. For example, the method 800B may be performed at the terminal device 110 as shown in FIG. 1. For the purpose of discussion, in the following, the method 800B will be described with reference to FIG. 1. It is to be understood that the method 800B may include additional blocks not shown and/or may omit some blocks as shown, and the scope of the present disclosure is not limited in this regard.

As shown in FIG. 8B, at block 810, the terminal device 110 may determine whether a time window for WUS detection is configured. If the time window is configured, the process proceeds to block 820. At block 820, the terminal device 110 may determine whether a WUS is received in the configured time window. If the WUS is received, the process proceeds to block 830. At block 830, the terminal device 110 may determine whether the WUS indicates that an on-duration operation is to be started.

If the WUS indicates to start the on-duration operation, the process proceeds to block 840. At block 840, the terminal device 110 may determine, as the target SSSG, a first SSSG in the configured set of SSSGs that comprises no search space set for monitoring the trigger signal.

In some embodiments, the first SSSG may be predefined or preconfigured. In some embodiments, the terminal device 110 may obtain, from the WUS, information of the first SSSG, and determine the first SSSG from the configured set of SSSGs based on the information of the first SSSG. In other words, the first SSSG may be indicated by the WUS.

In some embodiments, the terminal device 110 may determine a first candidate set of SSSGs from the configured set of SSSGs, each SSSG in the first candidate set of SSSGs comprising no search space set for monitoring the trigger signal, and determine, as the first SSSG, a SSSG having the lowest index in the first candidate set of SSSGs. In this way, the terminal device 110 may determine the first SSSG in a predefined rule.

With reference to FIG. 8B, if determining at block 810 that the time window is not configured, the process proceeds to block 850. If determining at block 820 that the WUS is not received in the configured time window, the process also proceeds to block 850. At block 850, the terminal device 110 may determine, as the target SSSG, a second SSSG in the configured set of SSSGs that comprises the search space set for monitoring the trigger signal. In some embodiments, the second search space set group may be predefined or preconfigured. Of course, any other suitable ways are also feasible.

If determining at block 830 that the WUS indicates to not start the on-duration operation, the process proceeds to block 860. At block 860, the terminal device 110 may not start the on-duration operation, i.e., keep sleeping.

It is to be understood that the process of FIG. 8B is merely an example, and the process of FIG. 8A may also be implemented in any other suitable ways.

FIG. 9 illustrates an example method 900 of communication implemented at a terminal device in accordance with some embodiments of the present disclosure. For example, the method 900 may be performed at the terminal device 110 as shown in FIG. 1.

For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 901, the terminal device 110 determines whether a SSSG switching from a first SSSG to a second SSSG is performed in a first short cycle of DRX. If the SSSG switching is performed, the process proceeds to block 902.

At block 902, the terminal device 110 determines a SSSG from multiple SSSGs based on a timer associated with DRX. In some embodiments, the timer associated with DRX may be a timer configured for a short cycle of DRX, for example, drx-ShortCycle Timer.

In some alternative embodiments, the timer associated with DRX may be a newly defined timer. In these embodiments, the terminal device 110 may start the timer when the SSSG switching occurs, pause the timer when the terminal device 110 is in inactive time, and resume the timer when the terminal device 110 is in active time.

In some embodiments, the terminal device 110 may determine whether the timer associated with DRX is running. If the timer is running, the terminal device 110 may determine the second SSSG as the SSSG. If the timer expires or is stopped, the terminal device 110 may determine the first SSSG or a default SSSG as the SSSG. In some embodiments, the default SSSG may be predefined or preconfigured.

At block 903, the terminal device 110 starts an on-duration operation of DRX based on the determined SSSG in a second short cycle of DRX, the second short cycle being later than the first short cycle. For example, the terminal device 110 may start an on-duration timer with the determined SSSG in the next one or more short DRX cycle. Then the terminal device 110 may perform downlink channel monitoring (e.g., PDCCH monitoring) in the on-duration.

With the method of FIG. 9, unnecessary SSSG switching may be avoided and power consumption may be reduced.

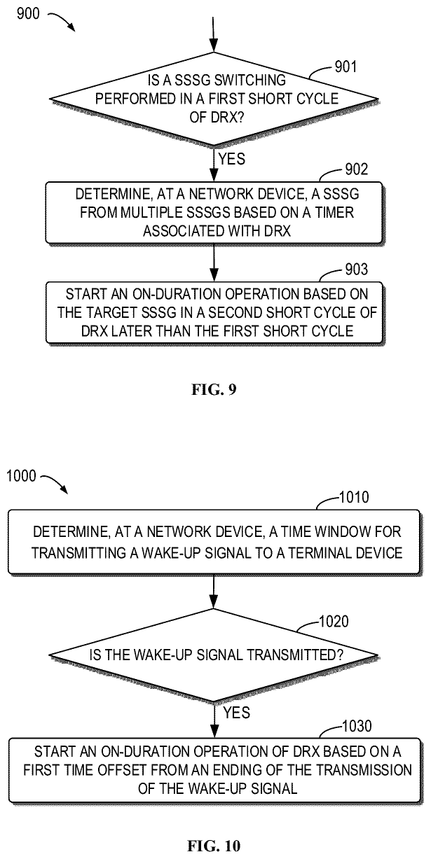

FIG. 10 illustrates an example method 1000 of communication implemented at a network device in accordance with some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the network device 120 determines a time window for transmitting a WUS to the terminal device 110. In some embodiments, the network device 120 may determine a reference starting time of the on-duration operation based on a first configuration for DRX, and determine a starting time of the time window based on the reference starting time and a second time offset from the reference starting time. Then the network device 120 may determine the time window based on the starting time of the time window and a duration configured for the WUS.

In some alternative embodiments, the network device 120 may determine a reference value at least based on a second configuration for a search space set for the WUS, determine a starting time of the time window based on an operation of rounding down or up the reference value, and determine the time window based on the starting time of the time window and a duration configured for the WUS. Then the network device 120 may transmit WUS in the time window:

At block 1020, the network device 120 determines whether a WUS is transmitted to the terminal device 110 in the time window: If the WUS is transmitted, the process 1000 proceeds to block 1030. At block 1030, the network device 120 starts an on-duration operation of DRX based on a first time offset from an end of the transmission of the WUS. For example, the network device 120 may start an on-duration timer at the first time offset from an end of the transmission of the WUS. In this way, the network device 120 may perform data transmission in the on-duration.

In some embodiments, the network device 120 may start the on-duration operation in a starting time unit after the first time offset from an end of a time unit in which the WUS is received. In some embodiments, the time unit comprises at least one of a slot, a symbol, or a sub-slot.

In some embodiments, the first time offset may be predefined or preconfigured. In some embodiments, the first time offset may be indicated by the WUS. In these embodiments, the network device 120 may transmit, to the terminal device 110, a first indication of the first time offset in the WUS.

In some embodiments, the WUS may comprise multiple wake-up indications for multiple terminal devices and a value of the first time offset to be applied for the multiple wake-up indications.

In some embodiments, the network device 120 may determine a duration of the on-duration operation based on a first configuration for DRX. In some embodiments, the network device 120 may determine a duration of the on-duration operation based on the first configuration for DRX and a predetermined duration. In some embodiments, the network device 120 may determine the predetermined duration based on a reference starting time of the on-duration operation and the time of the starting the on-duration operation, the reference starting time being determined based on the first configuration for DRX. In some embodiments, the network device 120 may determine the predetermined duration based on the remaining length of the time window after the end of the reception of the WUS. In some embodiments, the network device 120 may determine the predetermined duration based on the remaining length of the time window after an end of a slot in which the WUS is transmitted. In some embodiments, the network device 120 may transmit a second indication of the predetermined duration to the terminal device 110.

In some embodiments, in response to transmitting no WUS to the terminal device 110 in the time window; the network device 120 may start the on-duration operation of DRX at a reference starting time of the on-duration operation, the reference starting time being determined based on a first configuration for DRX. For example, the network device 120 may start an on-duration timer at the reference starting time. Then the network device 120 may perform data transmission in the on-duration.

In some embodiments, the network device 120 may determine multiple reference starting times of the on-duration operation based on a first configuration for DRX, determine multiple starting times for multiple time windows based on the multiple reference starting times and a third time offset from the multiple reference starting times, and determine, as the time window; the multiple time windows based on the multiple starting times and one or multiple durations configured for the multiple time windows. In some embodiments, the multiple starting times may be associated with an on-duration timer. In some alternative embodiments, each of the multiple starting times may be associated with one of multiple on-duration timers.

In some embodiments, in response to transmitting the WUS in a first time window of the multiple time windows, the network device 120 may start the on-duration operation at a first reference starting time of the multiple reference starting times, the first reference starting time being associated with the first time window: In some embodiments, in response to transmitting the WUS in a first time window of the multiple time windows, the network device 120 may stop monitoring of the WUS in remaining time windows of the multiple time windows.

With the method of FIG. 10, a starting time of a DRX cycle may be dynamically determined, and a good tradeoff between latency and power consumption may be achieved. Accordingly, latency may be reduced and power consumption may also be reduced.

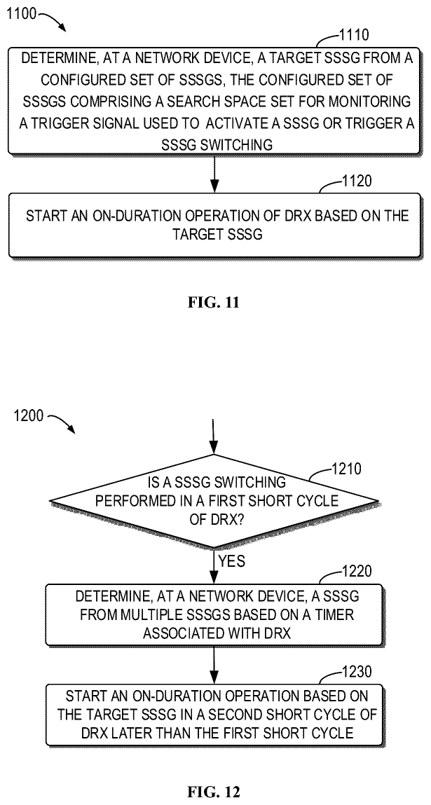

FIG. 11 illustrates an example method 1100 of communication implemented at a network device in accordance with some embodiments of the present disclosure. For example, the method 1100 may be performed at the network device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the network device 120 determines a target SSSG from a configured set of SSSGs, the configured set of SSSGs comprising a search space set for monitoring a trigger signal used to activate a SSSG or trigger a SSSG switching. In some embodiments, if a WUS is received and the WUS indicates that an on-duration operation of DRX is to be started, the network device 120 may determine, as the target SSSG, a first SSSG in the configured set of SSSGs that comprises no search space set for monitoring the trigger signal.

In some embodiments, the first SSSG may be predefined or preconfigured. In some embodiments, the network device 120 may determine the first SSSG from the configured set of SSSGs, and transmit, in the WUS, information of the first SSSG to the terminal device 110. In some embodiments, the network device 120 may determine a first candidate set of SSSGs from the configured set of SSSGs, each SSSG in the first candidate set of SSSGs comprising no search space set for monitoring the trigger signal, and determine, as the first SSSG, a SSSG having the lowest index in the first candidate set of SSSGs.

In some embodiments, if the WUS is not received in the time window or the time window is not configured, the network device 120 may determine, as the target SSSG, a second SSSG in the configured set of SSSGs that comprises the search space set for monitoring the trigger signal. In some embodiments, the second search space set group may be predefined or preconfigured. Of course, any other suitable ways are also feasible.

At block 1120, the network device 120 starts an on-duration operation of DRX based on the target SSSG. For example, the network device 120 may start an on-duration timer with the target SSSG. Then the network device 120 may perform data transmission in the on-duration with the target SSSG.

In this way, a trigger signal is introduced to fully wake up a terminal device from a low power mode in which the terminal device is not required to monitor scheduling DCI. Thereby; power consumption may be reduced.

FIG. 12 illustrates an example method 1200 of communication implemented at a network device in accordance with some embodiments of the present disclosure. For example, the method 1200 may be performed at the network device 120 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

At block 1210, the network device 120 determines whether a SSSG switching from a first SSSG to a second SSSG is performed in a first short cycle of DRX. If the SSSG switching is performed, the process proceeds to block 1220.

At block 1220, the network device 120 determines a SSSG from multiple SSSGs based on a timer associated with DRX. In some embodiments, the timer associated with DRX may be a timer configured for a short cycle of DRX, for example, drx-ShortCycle Timer.

In some alternative embodiments, the timer associated with DRX may be a newly defined timer. In these embodiments, the network device 120 may start the timer when the SSSG switching occurs, pause the timer when the terminal device 110 is in inactive time, and resume the timer when the terminal device 110 is in active time.

In some embodiments, the network device 120 may determine whether the timer associated with DRX is running. If the timer is running, the network device 120 may determine the second SSSG as the SSSG. If the timer expires or is stopped, the network device 120 may determine the first SSSG or a default SSSG as the SSSG. In some embodiments, the default SSSG may be predefined or preconfigured.

At block 1230, the network device 120 starts an on-duration operation of DRX based on the determined SSSG in a second short cycle of DRX, the second short cycle being later than the first short cycle. For example, the network device 120 may start an on-duration timer with the determined SSSG in the next one or more short DRX cycle. Then the network device 120 may perform data transmission in the on-duration with the determined SSSG.

With the method of FIG. 12, unnecessary SSSG switching may be avoided and system performance may be enhanced.

### Example Implementation of Device

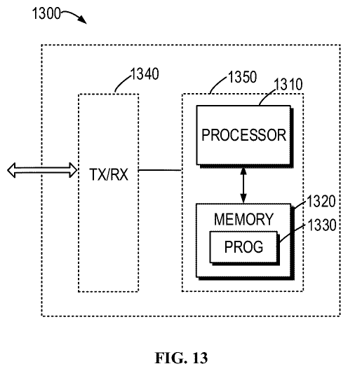

FIG. 13 is a simplified block diagram of a device 1300 that is suitable for implementing embodiments of the present disclosure. The device 1300 can be considered as a further example implementation of the terminal device 110 or the network device 120 as shown in FIG. 1. Accordingly, the device 1300 can be implemented at or as at least a part of the terminal device 110 or the network device 120.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 3A to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a terminal device comprises circuitry configured to: determine a time window for monitoring a wake-up signal from a network device; and in response to receiving the wake-up signal from the network device in the time window; start an on-duration operation of discontinuous reception based on a first time offset from an end of the reception of the wake-up signal.

In some embodiments, the circuitry may be configured to start the on-duration operation by starting the on-duration operation in a starting time unit after the first time offset from an end of a time unit in which the wake-up signal is received. In some embodiments, the first time offset is predefined or preconfigured. In some embodiments, the circuitry may be further configured to obtain a first indication of the first time offset from the wake-up signal and determine the first time offset based on the first indication.

In some embodiments, the wake-up signal comprises multiple wake-up indications for multiple terminal devices and a value of the first time offset to be applied for the multiple wake-up indications.

In some embodiments, the circuitry may be further configured to determine a duration of the on-duration operation based on a first configuration for discontinuous reception, or determine a duration of the on-duration operation based on the first configuration for discontinuous reception and a predetermined duration.

In some embodiments, the circuitry may be further configured to at least one of: determine the predetermined duration based on a reference starting time of the on-duration operation and the time of the starting the on-duration operation, the reference starting time being determined based on the first configuration for discontinuous reception: determine the predetermined duration based on the remaining length of the time window after the end of the reception of the wake-up signal: determine the predetermined duration based on the remaining length of the time window after an end of a slot in which the wake-up signal is received: or determine the predetermined duration based on a second indication of the predetermined duration from the network device.

In some embodiments, the circuitry may be further configured to: in response to receiving no wake-up signal from the network device in the time window; start the on-duration operation of discontinuous reception at a reference starting time of the on-duration operation, the reference starting time being determined based on a first configuration for discontinuous reception.

In some embodiments, the circuitry may be further configured to determine the time window by determining multiple reference starting times of the on-duration operation based on a first configuration for discontinuous reception: determining multiple starting times for multiple time windows based on the multiple reference starting times and a third time offset from the multiple reference starting times; and determining, as the time window;

the multiple time windows based on the multiple starting times and one or multiple durations configured for the multiple time windows.

In some embodiments, the multiple starting times are associated with an on-duration timer, or wherein each of the multiple starting times are associated with one of multiple on-duration timers.

In some embodiments, the circuitry may be configured to start the on-duration operation by in response to receiving the wake-up signal in a first time window of the multiple time windows, starting the on-duration operation at a first reference starting time of the multiple reference starting times, the first reference starting time being associated with the first time window: In some embodiments, the circuitry may be further configured to: in response to receiving the wake-up signal in a first time window of the multiple time windows, stop monitoring of the wake-up signal in remaining time windows of the multiple time windows.

In some embodiments, the circuitry may be configured to determine the time window by: determining a reference starting time of the on-duration operation based on a first configuration for discontinuous reception: determining a starting time of the time window based on the reference starting time and a second time offset from the reference starting time; and determining the time window based on the starting time of the time window and a duration configured for the wake-up signal.

In some embodiments, the circuitry may be configured to determine the time window by: determining a reference value at least based on a second configuration for a search space set for the wake-up signal: determining a starting time of the time window based on an operation of rounding down or up the reference value; and determining the time window based on the starting time of the time window and a duration configured for the wake-up signal.

In some embodiments, a terminal device comprises a circuitry configured to: determine a target search space set group from a configured set of search space set groups, the configured set of search space set groups comprising a search space set for monitoring a trigger signal used to activate a search space set group or trigger a search space set group switching; and start an on-duration operation of discontinuous reception based on the target search space set group.

In some embodiments, the circuitry may be configured to determine the target search space set group by: in accordance with a determination that a wake-up signal is received and the wake-up signal indicates that an on-duration operation of discontinuous reception is to be started, determining, as the target search space set group, a first search space set group in the configured set of search space set groups that comprises no search space set for monitoring the trigger signal. In some embodiments, the first search space set group is predefined or preconfigured.

In some embodiments, the circuitry may be further configured to: obtain, from the wake-up signal, information of the first search space set group; and determine the first search space set group from the configured set of search space set groups based on the information of the first search space set group.

In some embodiments, the circuitry may be configured to determine the first search space set group by determining a first candidate set of search space set groups from the configured set of search space set groups, each search space set group in the first candidate set of search space set groups comprising no search space set for monitoring the trigger signal; and determining, as the first search space set group, a search space set group having the lowest index in the first candidate set of search space set groups.

In some embodiments, the circuitry may be configured to determine the target search space set group by: in accordance with a determination that no wake-up signal is received or no time window for a wake-up signal monitoring is configured, determining, as the target search space set group, a second search space set group in the configured set of search space set groups that comprises the search space set for monitoring the trigger signal. In some embodiments, the second search space set group is predefined or preconfigured.

In some embodiments, a terminal device comprise a circuitry configured to: in accordance with a determination that a search space set group switching from a first search space set group to a second search space set group is performed in a first short cycle of discontinuous reception, determine a search space set group from multiple search space set groups based on a timer associated with discontinuous reception; and start an on-duration operation of discontinuous reception based on the determined search space set group in a second short cycle of discontinuous reception, the second short cycle being later than the first short cycle.

In some embodiments, the circuitry may be configured to determine the search space set group by: determining whether the timer associated with discontinuous reception is running: in accordance with a determination that the timer is running, determining the second search space set group as the search space set group; and in accordance with a determination that the timer expires or is stopped, determining the first search space set group or a default search space set group as the search space set group. In some embodiments, the timer is a timer configured for a short cycle of discontinuous reception.

In some embodiments, the circuitry may be further configured to: start the timer when the search space set group switching occurs: pause the timer when the terminal device is in inactive time; and resume the timer when the terminal device is in active time.

In some embodiments, a network device comprises a circuitry configured to: determine a time window for transmitting a wake-up signal to a terminal device; and in response to transmitting the wake-up signal to the terminal device in the time window; start an on-duration operation of discontinuous reception based on a first time offset from an end of the transmission of the wake-up signal.

In some embodiments, the circuitry may be configured to start the on-duration operation by starting the on-duration operation in a starting time unit after the first time offset from an end of a time unit in which the wake-up signal is transmitted.

In some embodiments, the first time offset is predefined or preconfigured. In some embodiments, the circuitry may be further configured to transmit, to the terminal device, a first indication of the first time offset the first indication in the wake-up signal. In some embodiments, the wake-up signal comprises multiple wake-up indications for multiple terminal devices and a value of the first time offset to be applied for the multiple wake-up indications.

In some embodiments, the circuitry may be further configured to: determine a duration of the on-duration operation based on a first configuration for discontinuous reception, or determine a duration of the on-duration operation based on the first configuration for discontinuous reception and a predetermined duration.

In some embodiments, the circuitry may be further configured to at least one of: determine the predetermined duration based on a reference starting time of the on-duration operation and the time of the starting the on-duration operation, the reference starting time being determined based on the first configuration for discontinuous reception: determine the predetermined duration based on the remaining length of the time window after the end of the reception of the wake-up signal: determine the predetermined duration based on the remaining length of the time window after an end of a slot in which the wake-up signal is transmitted: or transmit a second indication of the predetermined duration to the terminal device.

In some embodiments, the circuitry may be further configured to: in response to transmitting no wake-up signal to the terminal device in the time window; start the on-duration operation of discontinuous reception at a reference starting time of the on-duration operation, the reference starting time being determined based on a first configuration for discontinuous reception.

In some embodiments, the circuitry may be configured to determine the time window by determining multiple reference starting times of the on-duration operation based on a first configuration for discontinuous reception: determining multiple starting times for multiple time windows based on the multiple reference starting times and a third time offset from the multiple reference starting times; and determining, as the time window; the multiple time windows based on the multiple starting times and one or multiple durations configured for the multiple time windows.

In some embodiments, the multiple starting times are associated with an on-duration timer, or wherein each of the multiple starting times are associated with one of multiple on-duration timers.

In some embodiments, the circuitry may be configured to start the on-duration operation by: in response to receiving the wake-up signal in a first time window of the multiple time windows, starting the on-duration operation at a first reference starting time of the multiple reference starting times, the first reference starting time being associated with the first time window:

In some embodiments, the circuitry may be further configured to: in response to transmitting the wake-up signal in a first time window of the multiple time windows, stop transmitting of the wake-up signal in remaining time windows of the multiple time windows.

In some embodiments, the circuitry may be configured to determine the time window by determining a reference starting time of the on-duration operation based on a first configuration for discontinuous reception: determining a starting time of the time window based on the reference starting time and a second time offset from the reference starting time; and determining the time window based on the starting time of the time window and a duration configured for the wake-up signal.

In some embodiments, the circuitry may be configured to determine the time window by determining a reference value at least based on a second configuration for a search space set for the wake-up signal: determining a starting time of the time window based on an operation of rounding down or up the reference value; and determining the time window based on the starting time of the time window and a duration configured for the wake-up signal.

In some embodiments, a network device comprises a circuitry configured to: determine a target search space set group from a configured set of search space set groups, the configured set of search space set groups comprising a search space set for monitoring a trigger signal used to activate a search space set group or trigger a search space set group switching; and start an on-duration operation of discontinuous reception based on the target search space set group.

In some embodiments, the circuitry may be configured to determine the target search space set group by: in accordance with a determination that a wake-up signal is received and the wake-up signal indicates that an on-duration operation of discontinuous reception is to be started, determining, as the target search space set group, a first search space set group in the configured set of search space set groups that comprises no search space set for monitoring the trigger signal.

In some embodiments, the first search space set group is predefined or preconfigured. In some embodiments, the circuitry may be further configured to: determine the first search space set group from the configured set of search space set groups; and transmit, in the wake-up signal, information of the first search space set group to the terminal device.

In some embodiments, the circuitry may be configured to determine the first search space set group by: determining a first candidate set of search space set groups from the configured set of search space set groups, each search space set group in the first candidate set of search space set groups comprising no search space set for monitoring the trigger signal; and determining, as the first search space set group, a search space set group having the lowest index in the first candidate set of search space set groups.

In some embodiments, the circuitry may be configured to determine the target search space set group by: in accordance with a determination that no wake-up signal is received or no time window for a wake-up signal monitoring is configured, determining, as the target search space set group, a second search space set group in the configured set of search space set groups that comprises the search space set for monitoring the trigger signal. In some embodiments, the second search space set group is predefined or preconfigured.

In some embodiments, a network device comprises a circuitry configured to: in accordance with a determination that a search space set group switching from a first search space set group to a second search space set group is performed in a first short cycle of discontinuous reception, determine a search space set group from multiple search space set groups based on a timer associated with discontinuous reception; and start an on-duration operation of discontinuous reception based on the determined search space set group in a second short cycle of discontinuous reception, the second short cycle being later than the first short cycle.

In some embodiments, the circuitry may be configured to determine the search space set group by: determining whether the timer associated with discontinuous reception is running: in accordance with a determination that the timer is running, determining the second search space set group as the search space set group; and in accordance with a determination that the timer expires or is stopped, determining the first search space set group or a default search space set group as the search space set group. In some embodiments, the timer is a timer configured for a short cycle of discontinuous reception.

In some embodiments, the circuitry may be further configured to: start the timer when the search space set group switching occurs: pause the timer when the terminal device is in inactive time; and resume the timer when the terminal device is in active time.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3A to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a terminal device, a time window for monitoring a wake-up signal from a network device; and
in response to receiving the wake-up signal from the network device in the time window, starting an on-duration operation of discontinuous reception based on a first time offset from an end of the reception of the wake-up signal.

2. The method of claim 1, wherein starting the on-duration operation comprises:
starting the on-duration operation in a starting time unit after the first time offset from an end of a time unit in which the wake-up signal is received.

3. (canceled)

4. The method of claim 1, further comprising:
obtaining a first indication of the first time offset from the wake-up signal; and
determining the first time offset based on the first indication.

5. The method of claim 1, wherein the wake-up signal comprises multiple wake-up indications for multiple terminal devices and a value of the first time offset to be applied for the multiple wake-up indications.

6. The method of claim 1, further comprising:
determining a duration of the on-duration operation based on a first configuration for discontinuous reception, or
determining a duration of the on-duration operation based on the first configuration for discontinuous reception and a predetermined duration.

7. The method of claim 6, further comprising at least one of:
determining the predetermined duration based on a reference starting time of the on-duration operation and the time of the starting the on-duration operation, the reference starting time being determined based on the first configuration for discontinuous reception,
determining the predetermined duration based on the remaining length of the time window after the end of the reception of the wake-up signal,
determining the predetermined duration based on the remaining length of the time window after an end of a slot in which the wake-up signal is received, or
determining the predetermined duration based on a second indication of the predetermined duration from the network device.

8. The method of claim 1, further comprising:
in response to receiving no wake-up signal from the network device in the time window, starting the on-duration operation of discontinuous reception at a reference starting time of the on-duration operation, the reference starting time being determined based on a first configuration for discontinuous reception.

9. The method of claim 1, wherein determining the time window comprises:
determining multiple reference starting times of the on-duration operation based on a first configuration for discontinuous reception;
determining multiple starting times for multiple time windows based on the multiple reference starting times and a third time offset from the multiple reference starting times; and
determining, as the time window, the multiple time windows based on the multiple starting times and one or multiple durations configured for the multiple time windows.

10. The method of claim 9, wherein the multiple starting times are associated with an on-duration timer, or
wherein each of the multiple starting times are associated with one of multiple on-duration timers.

11. The method of claim 9, wherein starting the on-duration operation comprises:
in response to receiving the wake-up signal in a first time window of the multiple time windows, starting the on-duration operation at a first reference starting time of the multiple reference starting times, the first reference starting time being associated with the first time window.

12. The method of claim 9, further comprising:
in response to receiving the wake-up signal in a first time window of the multiple time windows, stopping monitoring of the wake-up signal in remaining time windows of the multiple time windows.

13. The method of claim 1, wherein determining the time window comprises:
determining a reference starting time of the on-duration operation based on a first configuration for discontinuous reception;
determining a starting time of the time window based on the reference starting time and a second time offset from the reference starting time; and
determining the time window based on the starting time of the time window and a duration configured for the wake-up signal.

14. The method of claim 1, wherein determining the time window comprises:
determining a reference value at least based on a second configuration for a search space set for the wake-up signal;
determining a starting time of the time window based on an operation of rounding down or up the reference value; and
determining the time window based on the starting time of the time window and a duration configured for the wake-up signal.

15. A method of communication, comprising:
determining, at a terminal device, a target search space set group from a configured set of search space set groups, the configured set of search space set groups comprising a search space set for monitoring a trigger signal used to activate a search space set group or trigger a search space set group switching; and
starting an on-duration operation of discontinuous reception based on the target search space set group.

16. The method of claim 15, wherein determining the target search space set group comprises:
in accordance with a determination that a wake-up signal is received and the wake-up signal indicates that an on-duration operation of discontinuous reception is to be started, determining, as the target search space set group, a first search space set group in the configured set of search space set groups, wherein the first search space set group comprises no search space set for monitoring the trigger signal.

17. (canceled)

18. (canceled)

19. The method of claim 16, wherein determining the first search space set group comprises:
determining a first candidate set of search space set groups from the configured set of search space set groups, wherein each search space set group in the first candidate set of search space set groups comprises no search space set for monitoring the trigger signal; and
determining, as the first search space set group, a search space set group having the lowest index in the first candidate set of search space set groups.

20. The method of claim 15, wherein determining the target search space set group comprises:
in accordance with a determination that no wake-up signal is received or no time window for a wake-up signal monitoring is configured, determining, as the target search space set group, a second search space set group in the configured set of search space set groups, wherein the second search space set group comprises the search space set for monitoring the trigger signal.

21. (canceled)

22. A method of communication, comprising:
in accordance with a determination that a search space set group switching from a first search space set group to a second search space set group is performed in a first short cycle of discontinuous reception, determining, at a terminal device, a search space set group from multiple search space set groups based on a timer associated with discontinuous reception; and
starting an on-duration operation of discontinuous reception based on the determined search space set group in a second short cycle of discontinuous reception, the second short cycle being later than the first short cycle.

23. The method of claim 22, wherein determining the search space set group comprises:
determining whether the timer associated with discontinuous reception is running;
in accordance with a determination that the timer is running, determining the second search space set group as the search space set group; and
in accordance with a determination that the timer expires or is stopped, determining the first search space set group or a default search space set group as the search space set group.

24. (canceled)

25. The method of claim 22, further comprising:
starting the timer when the search space set group switching occurs;
pausing the timer when the terminal device is in inactive time; and
resuming the timer when the terminal device is in active time.

26-52. (canceled)
